(19) United States
(12) Patent Application Publication
(10) Pub. No.: US 2026/0329422 A1
(43) Pub. Date: Oct. 22, 2026

(54) System and Method for Dynamically Adjusting Content Levels in User Interfaces

(71) Applicant: The Toronto-Dominion Bank, Toronto (CA)

(72) Inventors: Mohamed ABBAS, Jersey City, NJ (US); Angela CHOO, Ottawa (CA); Anil Stewart BAKHLE, Guelph (CA); Prerak Bhavnesh TRIVEDI, Toronto (CA); Mya Ella CERTOSSI, Kitchener (CA)

(73) Assignee: The Toronto-Dominion Bank, Toronto (CA)

(21) Appl. No.: 19/182,152

(22) Filed: Apr. 17, 2025

(51) Int. Cl. G06F 3/04845; G06F 3/04883

(52) U.S. Cl. CPC G06F 3/04845; G06F 3/04883; G06F 2203/04806

(57) ABSTRACT

System, method and device for dynamically adjusting content levels in user interfaces. The method includes, responsive to detecting an interactive input applied to content displayed in a user interface, processing the interactive input to determine a direction to adjust a scale factor, the scale factor being associated with different levels of detail for the content, the content comprising a first level of detail. The method also includes determining a second level of detail for the content that has been obtained by prompting a large language model (LLM), the second level of detail comprising more or less detail than the first level of detail according to the direction applied to adjust the scale factor; and presenting the second level of detail in the user interface.

### TECHNICAL FIELD

The following relates generally to adjusting content in user interfaces and, more particularly, to adjusting a level of detail in such content, e.g., dynamically in response to interactive inputs.

### BACKGROUND

Artificial intelligence (AI)-powered chat interfaces are difficult to manage: it is easy to generate enough information to overload the chat interface, or to generate a response that lacks the required detail, etc. Current systems may lack intuitive, real-time methods for controlling the amount of, and the approach to displaying, generated content. That is, current approaches frequently lead to inefficient information consumption and poor operability and navigation.

### BRIEF DESCRIPTION OF THE DRAWINGS

Embodiments will now be described with reference to the appended drawings wherein:

FIG. 1 is a schematic diagram of an example computing environment.

FIG. 2 illustrates a process workflow executed by a content engine in the computing environment.

FIG. 3 illustrates a configuration for an input detector of the content engine.

FIG. 4 illustrates a configuration for a content summarizer of the content engine.

FIG. 5 illustrates levels of detail for content stored in a content cache.

FIGS. 6a, 6b, and 6c are user interfaces that illustrate the application of interactive inputs to increase or decrease the level of detail in initial content requested in a user interface.

FIGS. 7a and 7b are user interfaces that illustrate the application of an interactive input to increase the level of detail of a portion of content that exists in a user interface.

FIG. 8 is a block diagram of an example configuration for the content engine.

FIG. 9 is a block diagram of an example configuration for an enterprise system.

FIG. 10 is a block diagram of an example configuration of a client device.

FIG. 11 is a flow chart illustrating example operations that may be performed in adjusting content levels in user interfaces.

FIG. 12 is a flow chart illustrating example operations that may be performed in generating and/or caching multiple levels of detail associated with content.

FIG. 13 is a flow chart illustrating example operations that may be performed in generating and dynamically adjusting the level of detail in content based on a request for such content.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

Users may want to be able to quickly and dynamically summarize or expand content, e.g., AI-generated content, in a user interface (UI). This may include user interfaces that present content to users as well as chat interfaces, which may allow users to request certain content. To interact dynamically with such content, it is recognized that interactive inputs such as touch gestures provide an intuitive and efficient way to signal to the UI whether more or less detail for that content is desired (e.g., by applying a pinch-to-zoom gesture). In this way, users can efficiently access the level of detail they need without interrupting their workflow or by requiring the need to request new responses or access different programs or functions to modify or add to the existing content in the UI.

Consider the following use case. A user of an application receives a lengthy generated response explanation about a topic or domain, e.g., troubleshooting instructions, medical advice, investment strategies, etc. By pinching in, they can quickly summarize the key points or obtain a brief overview or by pinching out, obtain more detailed information. Similarly, in a language translation, the user can move between simple translations or more complex sentence structures.

The computing system described herein introduces a gesture-based interaction method for dynamically adjusting the level of detail in content, particularly AI-generated content, within UIs, including chat interfaces.

By using intuitive interactive inputs such as gestures that may include, without limitation, pinch-to-zoom gestures; users can seamlessly summarize or expand the content, allowing for quick overview or in-depth exploration of information as needed. The computing system may utilize touch event listeners to detect multi-touch gestures, specifically pinch-in and pinch-out movements. These gestures trigger a content engine that may employ natural language processing (NLP) techniques for dynamic summarization and expansion of text. The computing system may additionally interface with one or more large language models (LLMs) to generate appropriate levels of detail based on the interactive input. An input-content mapping system may be employed to ensure smooth transitions between different levels of content detail, while a UI adapter can dynamically adjust the UI (e.g., chat display) to accommodate the changing content.

That is, the computing system may, for example, provide a method of interacting with AI-generated content in UIs such as those employing a chat or translation features. The UIs may use gesture controls, specifically pinch-to-zoom gestures allowing users to dynamically adjust the level of detail in AI generated responses by using intuitive touch gestures, enhancing user experience and information accessibility.

The computing system provides a seamless integration of gesture controls with dynamic AI content summarization and expansion, which allows a user interface to fluidly adjust the level of detail in AI-generated responses using familiar touch gestures, providing an increased level of control over information density in chat interfaces, or translation experiences. This improves the usability of the computing system and the UI.

The interactive inputs (e.g., gestures) may be designed and layered within the UI with certain AI processing capabilities, such as those that use both local/proprietary models and third-party systems such as publicly available or subscription-based LLMs. The computing system may include interconnected components that work to provide a fluid, smooth, interaction with the AI content that is generated whether in chat bubbles or interstitials. The architecture may be compatible with real-time communication to ensure decreased latency between a user applying the interactive input, where the UI can react and adjust the content to a summarized version, or a lengthier explanation, for example.

The computing system may also be capable of interpreting user intent and dynamically adjust the content while being adaptable when on different hardware, operating systems, and platforms.

The computing system may enhance information accessibility and comprehension and personalize a chat experience to individual needs and preferences. This can differentiate chat interfaces with unique, intuitive interaction, which can potentially reduce user cognitive load and information overload. The system can be applied across various industries and topics (e.g., technical support, finance, education, translation, customer service, healthcare, etc.). The system can also enhance the perceived intelligence and adaptability of AI agents.

According to one aspect, a computing system for dynamically adjusting content levels in user interfaces is provided. The computing system includes a processor, and a memory coupled to the processor. The memory stores computer executable instructions that when executed by the processor cause the computing system to, responsive to detecting an interactive input applied to content displayed in a user interface, process the interactive input to determine a direction to adjust a scale factor, the scale factor being associated with different levels of detail for the content, the content comprising a first level of detail; determine a second level of detail for the content that has been obtained by prompting a large language model (LLM), the second level of detail comprising more or less detail than the first level of detail according to the direction applied to adjust the scale factor; and present the second level of detail in the user interface.

In certain example embodiments, the system further comprises instructions to determine, in the user interface, a request for the content; use the request to obtain a response using the LLM, the response comprising at least the content at the first level of detail; and present the content at the first level of detail to enable the interactive input to be applied thereto.

In certain example embodiments, the request for the content prompts the LLM to obtain a plurality of levels of detail.

In certain example embodiments, the system further comprises instructions to cache the plurality of levels of detail for the content, wherein at least the second level of detail and a third level of detail are cached to enable the first level of detail to be replaced with either more or less detail according to the direction of the scale factor determined from the interactive input.

In certain example embodiments, the system further comprises instructions to analyze the user interface to determine the request.

In certain example embodiments, the second level of detail is obtained by prompting the LLM responsive to detect the interactive input.

In certain example embodiments, the second level of detail is presented by revising the first level of detail.

In certain example embodiments, the second level of detail is presented by replacing the content having the first level of detail with new content.

In certain example embodiments, the LLM is prompted to provide the different level of detail.

In certain example embodiments, the computing system processes a response from the LLM to generate the second level of detail.

In certain example embodiments, the computing system further comprises instructions to apply a predictive generation process to the response from the LLM to generate at least the second level of detail.

In certain example embodiments, the interactive input comprises gesture applied to the user interface.

In certain example embodiments, the gesture comprises a pinch-to-zoom gesture applied to the content to increase or decrease the scale factor.

In certain example embodiments, the interactive input is applied to a first portion of content in the user interface, the user interface presenting a plurality of portions of content to which the interactive input can be applied to adjust the level of detail for that content.

In another aspect, there is provided a method for dynamically adjusting content levels in user interfaces, the method being implemented by a computing system and comprising: responsive to detecting an interactive input applied to content displayed in a user interface, processing the interactive input to determine a direction to adjust a scale factor, the scale factor being associated with different levels of detail for the content, the content comprising a first level of detail; determining a second level of detail for the content that has been obtained by prompting a large language model (LLM), the second level of detail comprising more or less detail than the first level of detail according to the direction applied to adjust the scale factor; and presenting the second level of detail in the user interface.

In certain example embodiments, the method further includes determining, in the user interface, a request for the content; using the request to obtain a response using the LLM, the response comprising at least the content at the first level of detail; and presenting the content at the first level of detail to enable the interactive input to be applied thereto.

In certain example embodiments, the request for the content prompts the LLM to obtain a plurality of levels of detail.

In certain example embodiments, the method further includes caching the plurality of levels of detail for the content, wherein at least the second level of detail and a third level of detail are cached to enable the first level of detail to be replaced with either more or less detail according to the direction of the scale factor determined from the interactive input.

In certain example embodiments, the method further includes analyzing the user interface to determine the request.

In another aspect, there is provided a computer readable medium storing computer-executable instructions for dynamically adjusting content levels in user interfaces, comprising computer-executable instructions that, when executed by a computing system, cause the computing system to: responsive to detecting an interactive input applied to content displayed in a user interface, process the interactive input to determine a direction to adjust a scale factor, the scale factor being associated with different levels of detail for the content, the content comprising a first level of detail; determine a second level of detail for the content that has been obtained by prompting a large language model (LLM), the second level of detail comprising more or less detail than the first level of detail according to the direction applied to adjust the scale factor; and present the second level of detail in the user interface.

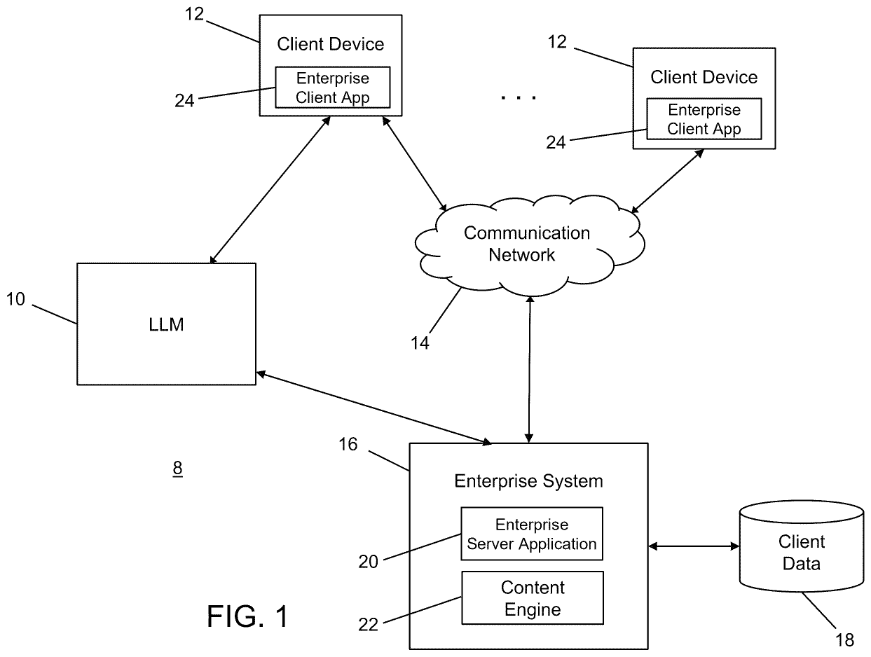

Referring now to the figures, FIG. 1 illustrates an example of a computing environment 8. In one aspect, the computing environment 8 may include one or more client devices 12, and one or more communications networks 14 connecting the components of the computing environment 8. The client devices 12 may include or otherwise have access to an LLM 10 via the communication network 14.

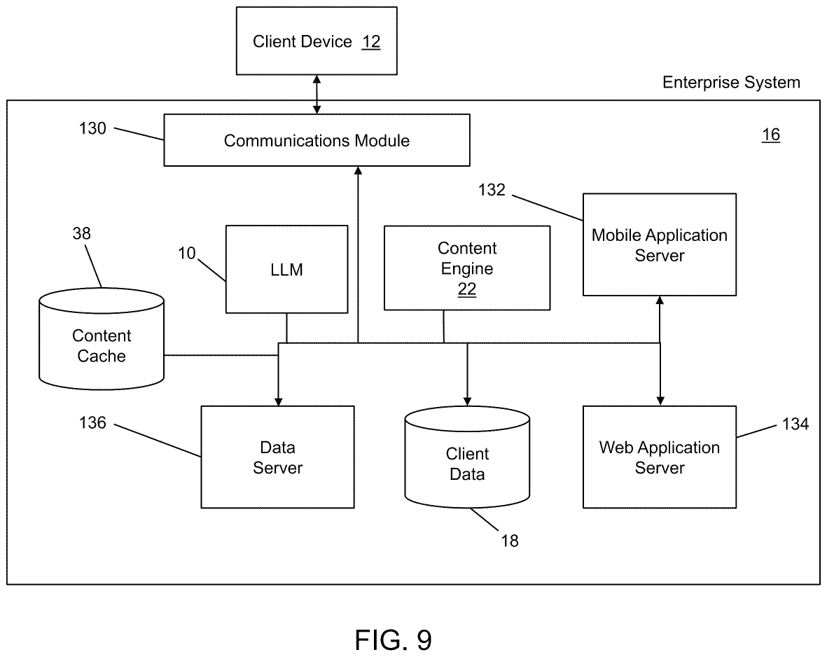

The computing environment 8 may also include an enterprise system 16 (e.g., a financial institution such as commercial bank and/or insurance provider) that provides financial services accounts to users and processes financial transactions associated with those financial service accounts. While several details of the enterprise system 16 have been omitted for clarity of illustration, reference will be made to FIG. 9 below for additional details. The enterprise system 16 includes, at least in part, an enterprise server application 20, which may be referred to as the server application 20 herein for brevity. The enterprise server application 20 may include or, as shown in FIG. 1, have access to a content engine 22. The content engine 22 enables the enterprise server application 20 to obtain and provide multiple levels of content for a UI provided by the enterprise client app 24 as described more fully below. It can be appreciated that the “levels” of content may refer to levels of detail, levels of translation or understanding related to a topic or domain.

A domain, as used herein, may refer to any collective body of knowledge, skills, experience or association of ideas, expertise or organization or hierarchy of content. This may include domains associated with a particular type of technology (e.g., for technical support related to a product or service), financial understanding (e.g., related to a financial product or service), medical or healthcare knowledge (e.g., related to medical or health related inquiries), etc. For such domains, the level of knowledge or expertise or exposure to the themes, ideas, specifications, metrics, etc. can vary and thus may be categorized into a number of levels (e.g., expert, knowledgeable, familiar, unaware, etc.).

The enterprise system 16 also includes or otherwise has access to a datastore for storing client data 18. The enterprise system 16 may include other datastores not shown in FIG. 1. The data associated with a user can include client profile data that may be mapped to corresponding data for that user. The corresponding data may include any data associated with a domain. The domain, as noted above, may be associated with any particular service or utility being provided by the enterprise system 16 and need not be limited to any particular examples herein. For example, a financial institution may have an enterprise system 16 whose client data 18 includes financial data. It can be appreciated that such financial data could also include transaction data and/or the client data 18 shown in FIG. 1 and these datastores are described separately for illustrative purposes. The client data 18 can include both data that is associated with a client as well as data that is associated with one or more user accounts for that client as recognized by the computing environment 8.

The data associated with a client may include, without limitation, demographic data (e.g., age, gender, income, location, etc.), preference data input by the client, and inferred data generated through machine learning, modeling, pattern matching, or other automated techniques. The client data 18 may also include historical interactions and transactions associated with the enterprise system 16, e.g., login history, search history, communication logs, documents, etc.

Client devices 12 may be associated with one or more users. Users may be referred to herein as customers, clients, policy holders, correspondents, or other entities that interact with the enterprise system 16 and/or LLM 10 (directly or indirectly). The computing environment 8 may include multiple client devices 12, each client device 12 being associated with a separate user or associated with one or more users. In certain embodiments, a user may operate client device 12 such that client device 12 performs one or more processes consistent with the disclosed embodiments. In the example shown in FIG. 1, the client device includes an enterprise client application (app) 24, which may also be referred to herein as a client app 24 for brevity.

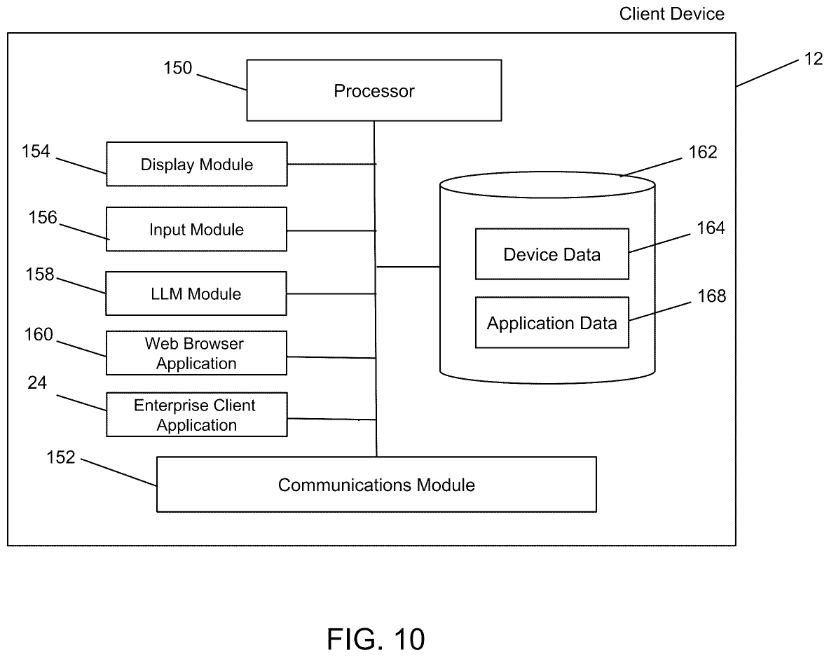

For example, the user may use client device 12 to engage and interface with a mobile or web-based financial (banking) application which uses or incorporates subsystems of the enterprise system 16, discussed further below. The client devices 12 in this example show a client app 24 but may also include a web browser application 160 (see FIG. 10) for accessing web-based applications.

The client devices 12 can access information within the enterprise system 16 and/or from the LLM 10, or another remote computing environment associated with the enterprise system 16 in a variety of ways. For example, the client device 12 can access the enterprise system 16 via a web-based application, or a dedicated application such as the client app 24, which corresponds to the enterprise server application 20. Access can require the provisioning of different types of credentials (e.g., login credentials, two factor authentication, etc.). In example embodiments, each different device 12 can be provided with a unique degree of access, or variations thereof. For example, the client device 12 can be provided with a greater degree of access to the enterprise system 16 compared to other devices.

In certain aspects, client device 12 can include, but is not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication network 14.

Communication network 14 may include a telephone network, cellular, and/or data communication network to connect different types of client devices 12. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), Wi-Fi or other similar wireless network(s), and a private and/or public wide area network (e.g., the Internet).

The enterprise system 16 can be understood to encompass the whole of the enterprise, a subset of a wider enterprise system (not shown), such as a system serving a subsidiary, or a system for a particular branch or team of the enterprise (e.g., a resource migration division of the enterprise). In at least one example embodiment, the enterprise system 16 is a financial institution system (e.g., a commercial bank) that provides financial services accounts to users and processes financial transactions associated with those financial service accounts. Such a financial institution system may provide to its customers various browser-based and mobile applications, e.g., for mobile banking, mobile investing, mortgage management, etc. Financial institutions can generate vast amounts of data, and have vast amounts of existing records, both of which can be migrated into digital and remote computing environments.

The enterprise system 16 may include both on-premises and remote computing assets provided by a remote computing environment-not shown (hereinafter referred to in the alternative as computing resources). The remote computing environment includes resources used by, or available, to the enterprise system 16 that are stored or managed by a party other than operator of the enterprise system 16. For example, the computing resources can include cloud-based storage services (e.g., database(s)). In at least some example embodiments, the computing resources include one or more tools developed or hosted by the external party, or tools for interacting with the computing resources. In at least one contemplated embodiment, the tool (referred to in the singular for ease of reference) is a tool for managing data lakes, and more specifically a tool for scheduling writing to a data lake associated with the Microsoft™ Azure™ data storage and processing platform. Further particularizing the example, the tool can allow a client device 12 to access the computing resources, and to thereafter configure an ingestion procedure wherein different data files are assigned to different processors (e.g., hardware) within the computing resources based on a configuration file. The tool can be or include aspects of a machine learning tool, or a tool associated with the Delta Lake Storage (ALDS)™ suite, etc. The computing resources can also include hardware resources, such as access to processing capability of server devices (e.g., cloud computing), and so forth.

The LLM 10 is shown as a separate entity in FIG. 1 for illustrative purposes and, in other configurations, may be part of or otherwise integrated into/with the enterprise system 16 (e.g., see FIG. 9). As shown in FIG. 1, the LLM 10 may be coupled to or in communication with the enterprise server application 20, via the enterprise system 16, to permit a user of a client device 12 to obtain a response related to a request that is submitted via the enterprise client app 24 and directed through the enterprise server application 20.

Referring again to FIG. 1, the enterprise system 16 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public and private keys in a PKI), and perform other cryptographic operations that are required or desired for particular applications of the enterprise system 16. The cryptographic server may be used to protect the financial data and/or client data 18 by way of encryption for data protection, digital signatures or message digests for data integrity, and by using digital certificates to authenticate the identity of the users and client devices 12, with which the enterprise system 16 communicates to inhibit data breaches by adversaries. It can be appreciated that various cryptographic mechanisms and protocols can be chosen and implemented to suit the constraints and requirements of the particular deployment of the enterprise system 16 as is known in the art.

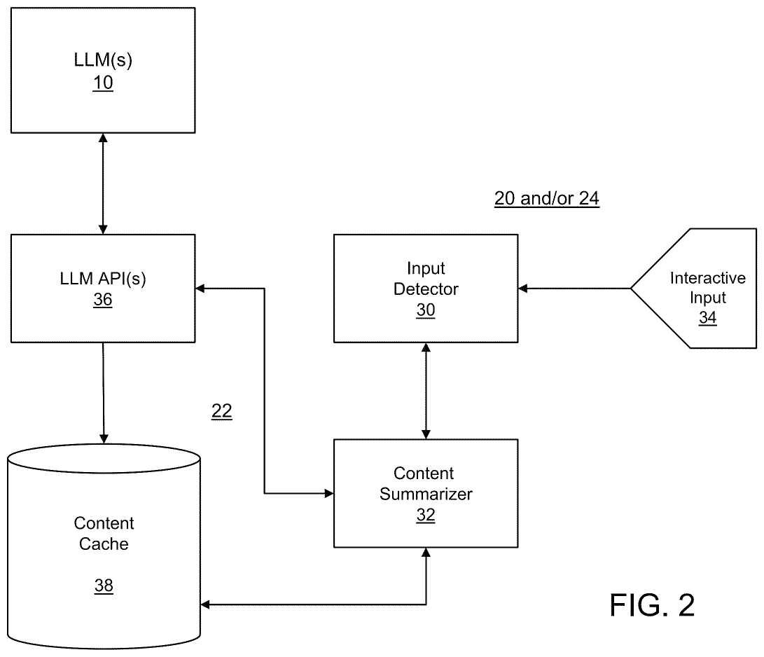

Turning now to FIG. 2, an example of a configuration for a process workflow utilized by/with the content engine 22 is shown. In this example, the content engine 22 receives or detects an interactive input 34 at an input detector 30. The input detector 30 may be utilized by the enterprise server application 20 or the client app 24, or both, to determine and indicate to the content engine 22 that the interactive input 34 has been received, e.g., at the client device 12. The input detector 30 may be coupled to a content summarizer 32, which may be used by the content engine 22 to determine multiple levels of detail or multiple amounts of content that is associated with the interactive input 34.

For example, a portion of content provided by a UI displayed by the client app 24 may be pre-processed (e.g., based on knowledge of the content) or, at the time of receiving the interactive input 34, dynamically processed, to generate or obtain more or less detail for the content that is, or is to be, displayed. The content summarizer 32 may utilize the LLM 10, e.g., via one or more LLM application programming interfaces (APIs) 36 or other computing interfaces, to automatically generate the more or less detail, by prompting the LLM 10.

The content engine 22 may include a content cache 38 that permits the content engine 22 to store, e.g., temporarily, the different levels of detail or versions of the content that are displayed by the UI. In this way, the UI can react dynamically to the interactive inputs 34, such as pinch-to-zoom, swipe, or other gestures with less latency. The different levels of detail may correspond to amounts of content (i.e., different volumes of data) or amounts of complexity (i.e., different levels of understanding or knowledge). The different levels may therefore be applied in various ways according to the nature of the content and the purpose of that content in the context of the client app 24, enterprise server application 20, or computing device 12. The cooperation between the client app 24, enterprise server application 20, and content engine 22 may be adapted for different scenarios, e.g., to account for offline situations where the content cache 38 can preload the different levels of content for the UI. Similarly, adaptive caching techniques may be applied based on connectivity, availability, speed, processing power, storage capabilities, etc.

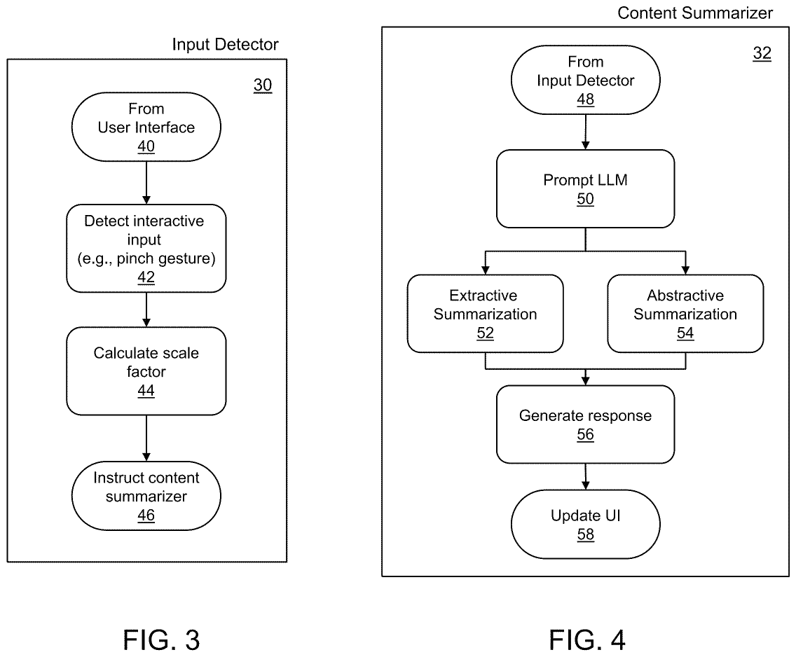

FIG. 3 illustrates an example of a configuration for implementing the input detector 30. The input detector 30, as noted above, may be implemented on either or both the client side or the server side of the computing environment 8. For example, the input detector 30 may include a client-side module in the client app 24 that is used to detect an interactive input 34 and provide a signal or message to the enterprise server application 20 indicative of receipt of the interactive input 34 and at least one property associated with the interactive input 34, e.g., a direction (pinch, spread, swipe up, swipe down, etc.). In this example, the interactive input 34 applied to the UI associated with the client app 24 at block 40, may be detected by the input detector 30 at block 42. At block 44, the input detector 30 may utilize data and information gathered from or provided by the UI at block 40 to calculate a scale factor at block 44. For example, the nature of the interactive input 34 may signal that more or less content is desired, as well as a degree of increase or decrease in that amount of content. In the case of a pinch-to-zoom or swipe gesture, for instance, the amount of spread between contact points (in a pinch or spread) or the amount of travel of the contact point (in a swipe) can be correlated to an amount of adjustment of the scale factor (e.g., 1×, 2×, 3×, 0.5×, 0.25×, etc.). The calculated scale factor at block 44 may be used to instruct the content summarizer 32 at block 46. It can be appreciated that the scale factor determined at block 44 may be associated with a sensitivity metric for the input mechanism (e.g., touchscreen) used to obtain the interactive input 34. The sensitivity metric may be user adjustable or based on preferences, defaults or other external factors such as the nature of the client app 24 and the type of content being displayed by the UI.

FIG. 4 illustrates an example of a configuration for implementing the content summarizer 32. At block 48, the content summarizer 32 obtains an input from the input detector 30, e.g., that conveys or includes a scale factor indicative of an amount of detail to obtain or generate, in order to update, revise or replace associated content. The input at block 48 may be obtained dynamically, e.g., in real-time as interactive inputs 34 are detected, or may be done as a pre-processing routine to cache multiple levels of content that can be accessed by using the interactive input 34. The input detector 30 and content summarizer 32 may therefore be utilized on both static and dynamic content. An example of static content is a portion of content to be presented in a UI that is predetermined and can be interacted with to summarize or expand. An example of dynamic content is content that a user or other entity creates (e.g., in a chat UI, translation tool, etc.). In this way, the interactive input 34 may be processed in real-time to dynamically adjust content as it is consumed.

At block 50, the content summarizer 32 may prompt the LLM 10 to obtain both extractive summarizations 52 and abstractive summarizations 54, i.e., to prompt the LLM 10 to obtain more, less, or different amounts or types of content (e.g., translations with different dialects, different programming languages or operating systems, different country-specific regulations, etc.). The content summarizer 32 may then generate a response at block 56 to enable the client app 24 and/or enterprise server application 20 to update the UI at block 58.

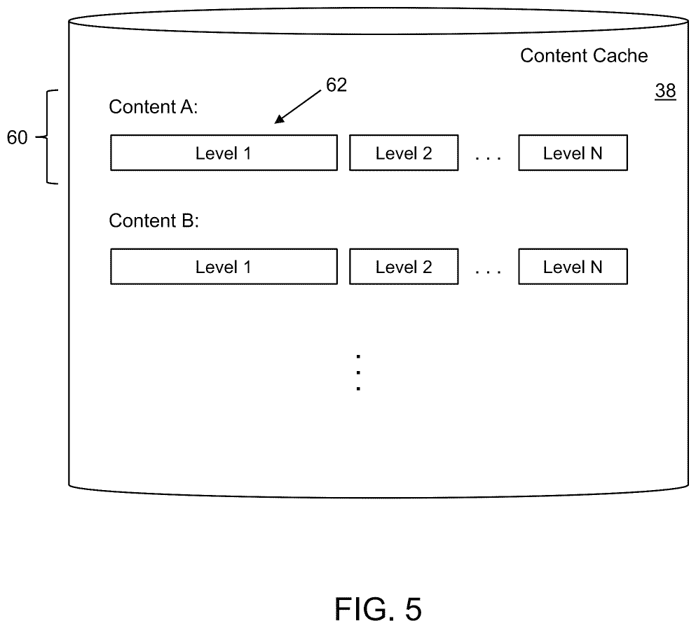

Referring now to FIG. 5, an example of a configuration for the content cache 38 is shown. In this example, a content portion 60 may include a number of content levels 62, namely Level 1, Level 2, . . . Level N in this illustration. The different levels 62 for the content may be generated using a predictive generation process, in order to provide what the content engine 22 predicts the user may wish to know, either more or less. Each content portion 60 may have associated information such as whether the content is a dynamic or static portion of content 60, its position on the display, its location within the client app 24 (e.g., which page, which tab, etc.). The content cache 38 may be used to pre-process content and/or dynamically store content portions 60 temporarily, e.g., in a chat or other dynamic scenario. Other details such as flags, tags, or metadata (not shown) may be stored with a content portion 60. For example, a dynamic tag may be applied to indicate that the content portion 60 is being store temporarily, e.g., for a conversation session or time period.

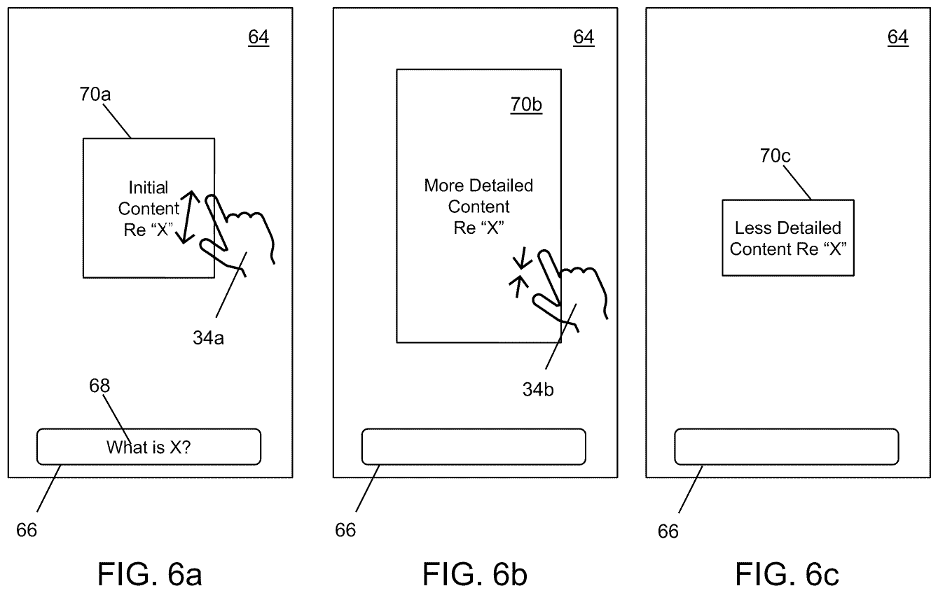

FIGS. 6a, 6b, and 6c illustrate an example of a UI 64 that is currently displaying a portion of displayed content 70, with a first or initial version or amount of displayed content 70a shown in FIG. 6a. The UI 64 in this example includes an entry box 66 to enable a user to enter a question or request 68. The request 68 causes the content engine 22 to obtain, generate, or have generated, the initial content 70a. For the purposes of illustration, the initial content 70a is shown as a certain size. A first interactive input 34a, which corresponds to a spread of a pair of contact points (e.g., fingers) in a pinch-to-zoom type gesture is applied to the initial content 70a as shown in FIG. 6a.

Referring next to FIG. 6b, it can be seen that the spread action has caused the scale factor to be increased such that a first modified content 70b is relatively larger than the initial content 70a. As shown in FIG. 6c, a pinch gesture (i.e., second interactive input 34b) may be applied to the first modified content 70b to generate second modified content 70c as shown in FIG. 6.

It can be seen that in this example, the second modified content 70c is relatively smaller than both the first modified content 70b and the initial content 70a to show that a relatively more pronounced pinch gesture has caused the content 70 to shrink even more (or provide less) than the initial content 70a. This can be signaled to the content engine 22 by way of correlating the scale factor to an amount or degree of interactive input 34, in this case, by pinching more, in FIG. 6b, than the spreading applied in FIG. 6a. It can be appreciated that while FIGS. 6a-6c illustrate the applied of the varying “levels” of content using size, the same principles may be applied to levels of detail, amount of expertise or complexity to a topic or domain, or specificity in a translation, to name a few.

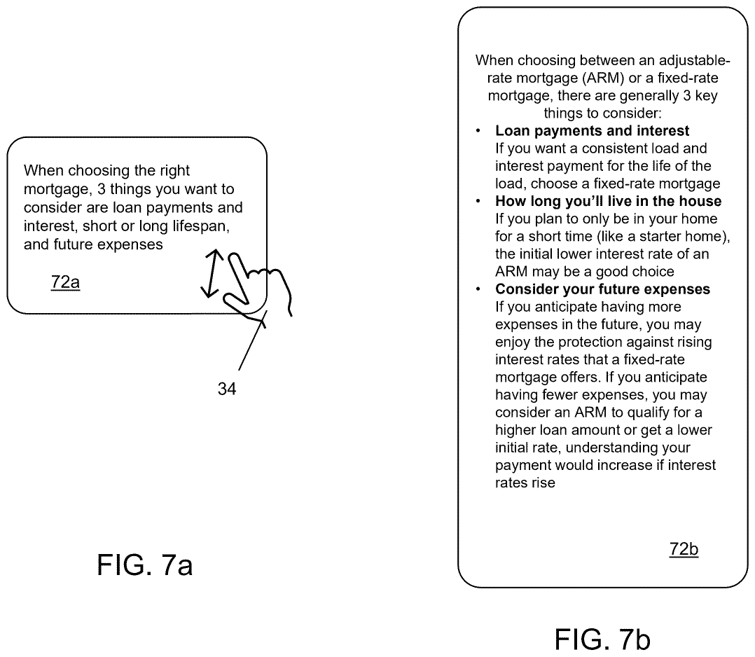

Another example of a varying level of detail can be found in FIGS. 7a and 7b. As shown in FIG. 7a, an initial content portion 72a may be displayed in a UI. For the purpose of this example, the initial content portion 72a may be a static portion of the UI or a response to a request 68, e.g., as shown in FIG. 6a. In this example, a high level set of factors related to mortgages is shown. By applying an interactive input 34 as seen in FIG. 7a, in this case a spread gesture, a modified content portion 72b may be shown, e.g., by expanding the initial content portion 72a. In this example, the modified content portion 72b includes additional detail for the user to consume. The content engine 22 may obtain the higher level of detail in this case by prompting the LLM 10 using the initial content portion 72a, e.g., by tokenizing the terms and concepts in the initial content portion 72a to obtain a suitable response that can be adapted for the modified content portion 72b

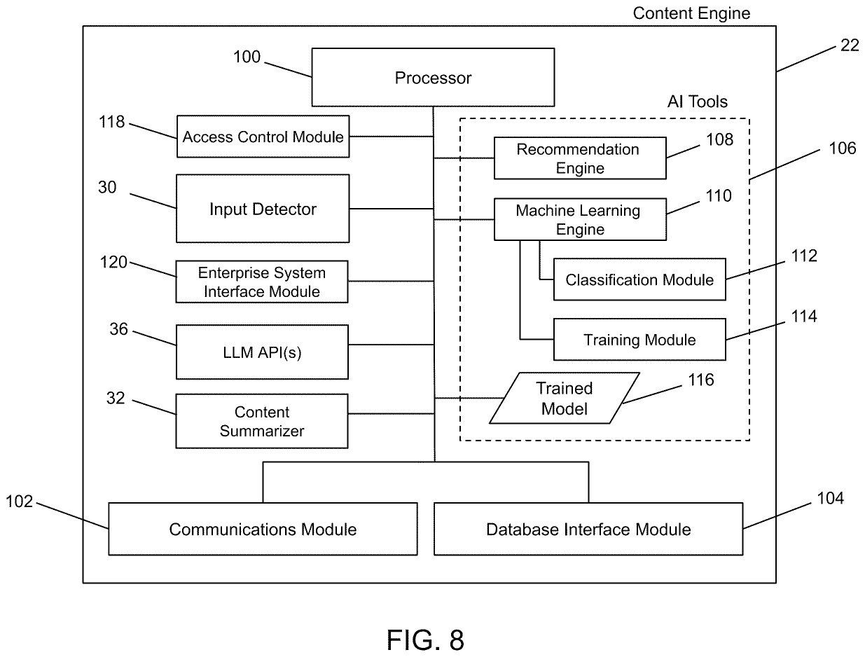

In FIG. 8, an example configuration of the content engine 22 is shown. In certain example embodiments, the content engine 22 may include one or more processors 100, a communications module 102, and a database interface module 104 for interfacing with the datastores and other data sources, to retrieve, modify, and store (e.g., add) data. Communications module 102 enables the content engine 22 to communicate with one or more other components of the computing environment 8, such as client device 12, enterprise system 16, or LLM 10, via a bus or other communication network, such as the communication network 14. While not delineated in FIG. 8, the content engine 22 includes at least one memory or memory device that can include a tangible and non-transitory computer-readable medium having stored therein computer programs, sets of instructions, code, or data to be executed by processor 100.

FIG. 8 illustrates examples of modules, tools and engines stored in memory on the content engine 22 and executed by the processor 100. It can be appreciated that any of the modules, tools, and engines shown in FIG. 8 may also be hosted externally and be available to the content engine 22, e.g., via the communications module 102. In the example embodiment shown in FIG. 8, the content engine 22 includes a suite or set of AI tools 106. The AI tools 106 include or otherwise have access to a recommendation engine 108, a machine learning engine 110, a classification module 112, a training module 114, and at least one trained model 116. The content engine 22 also includes an access control module 118, the input detector 30, the content summarizer 32, and the one or more LLM APIs 36. The content engine 22 may also include an enterprise system interface module 120 to enable the content engine 22 to interface with the enterprise server application 20 and enterprise system 16 more generally. The LLM API(s) 36 can enable the content engine 22 and the AI tools 106 to access the LLM 10 (e.g., third party LLM for generating responses to requests, etc.).

The recommendation engine 108 is used by the AI tools 106 of the content engine 22 to generate one or more recommendations for the content engine 22 and/or a client device 12 that is/are related to generating different levels of content as described above. It may be noted that a recommendation as used herein may refer to a prediction, suggestion, inference, association or other recommended identifier that can be used to generate a suggestion, notification, command, instruction or other data that can be viewed, used or consumed by the content engine 22. The recommendation engine 108 can access data and information and apply one or more inference processes to generate the recommendation(s). The recommendation engine 108 may utilize or otherwise interface with the machine learning engine 110 to both classify data currently being analyzed to generate a suggestion or recommendation, and to train classifiers using data that is continually being processed and accumulated by the content engine 22. That is, the recommendation engine 108 can learn segmentation outcomes, risk tiers and risk assessments, utilize confusion matrices, etc., and revise and refine classifications, rules or other analytics-related parameters over time. For example, the trained model 116 can be updated and refined using the training module 114 as client devices 12 and/or the content engine 22 interact with the client app 24 and/or enterprise server application 20, during various interactions to improve the AI/ ML parameters and understanding of how certain behaviors relate to, for example, domain literacy.

The machine learning engine 110 may also perform operations that classify the segmentation and other data (e.g., client data 18) in accordance with corresponding classifications parameters, e.g., based on an application of one or more machine learning algorithms to the data or groups of the data. The machine learning algorithms may include, but are not limited to, a one-dimensional, convolutional neural network model (e.g., implemented using a corresponding neural network library, such as Keras®), and the one or more machine learning algorithms may be trained against, and adaptively improved, using elements of previously classified profile content identifying suitable matches between content identified and potential actions to be executed. Subsequent to classifying the decision-related content or content being analyzed, the recommendation engine 108 may further process each element of the content to identify, and extract, a value characterizing the corresponding one of the classification parameters, e.g., based on an application of one or more additional machine learning algorithms to each of the elements of the decision-related content. By way of example, the additional machine learning algorithms may include, but are not limited to, an adaptive NLP algorithm that, among other things, predicts starting and ending indices of a candidate parameter value within each element of the content, extracts the candidate parameter value in accordance with the predicted indices, and computes a confidence score for the candidate parameter value that reflects a probability that the candidate parameter value accurately represents the corresponding classification parameter. As described herein, the one or more additional machine learning algorithms may be trained against, and adaptively improved using, the locally maintained elements of previously classified content. The LLM API(s) 36 (or any suitable computing connection made between the content engine 22 and the LLM 10) may be used to additionally access and prompt the LLM 10 for creating generative content. Classification parameters may be stored and maintained using the classification module 112, and training data may be stored and maintained using the training module 114.

The trained model 116 may also be created, stored, refined, updated, re-trained, and referenced by the content engine 22 (e.g., by way of the AI tools 106) to determine associations between actions and outcomes associated with behavior, and suitable responses or actions, and/or content related thereto. Such associations can be used to generate recommendations or suggestions for improving decisions being made, e.g., for determining when and how to act on such activity and behaviors to improve the content selection by the content engine 22.

In some instances, classification data stored in the classification module 112 may identify one or more parameters, e.g., “classification” parameters, that facilitate a classification of corresponding elements or groups of recognized content based on any of the exemplary machine learning algorithms or processes described herein. The one or more classification parameters may correspond to parameters that can indicate an affinity or compatibility between decision parameters and outcomes (e.g., approve or deny), and certain potential actions.

In some instances, the additional, or alternate, machine learning algorithms may include one or more adaptive, NLP algorithms capable of parsing each of the classified portions of the content and predicting a starting and ending index of the candidate parameter value within each of the classified portions. Examples of the adaptive, NLP algorithms include, but are not limited to, NLP models that leverage machine learning processes or artificial neural network processes, such as a named entity recognition model implemented using a SpaCy® library.

Examples of these adaptive, machine learning processes include, but are not limited to, one or more artificial, neural network models, such as a one-dimensional, convolutional neural network model, e.g., implemented using a corresponding neural network library, such as Keras®. In some instances, the one-dimensional, convolutional neural network model may implement one or more classifier functions or processes, such a Softmax® classifier, capable of predicting an association between an element of event data (e.g., a value or type of data being augmented with an event or workflow) and a single classification parameter and additionally, or alternatively, multiple classification parameters.

Based on the output of the one or more machine learning algorithms or processes, such as the one-dimensional, convolutional neural network model described herein, machine learning engine 110 may perform operations that classify each of the discrete elements of decision-related content as a corresponding one of the classification parameters, e.g., as obtained from classification data stored by the classification module 112.

The outputs of the machine learning algorithms or processes may then be used by the recommendation engine 108 to generate one or more suggested recommendations, instructions, commands, notifications, rules, or other instructional or observational elements that can be presented to the AI tools 106. The AI tools 106 may be used by any one or more of the operations shown in FIGS. 2-4 and 6-7 described herein. Similarly, the AI tools 106 may use the LLM API(s) 36 to access third party sources such as GPT-type services that use their own LLMs 10.

In FIG. 9, an example configuration of an enterprise system 16 is shown. The enterprise system 16 includes a communications module 130 that enables the enterprise system 16 to communicate with one or more other components of the computing environment 8, such as the LLM 10 and/or client device(s) 12, via a bus or other communication network, such as the communication network 14. While not delineated in FIG. 9, the enterprise system 16 includes at least one memory or memory device that can include a tangible and non-transitory computer-readable medium having stored therein computer programs, sets of instructions, code, or data to be executed by one or more processors (not shown for clarity of illustration). FIG. 9 illustrates examples of servers and datastores/databases operable within the enterprise system 16. It can be appreciated that any of the components shown in FIG. 9 may also be hosted externally and be available to the enterprise system 16, e.g., via the communications module 130.

In the example embodiment shown in FIG. 9, the enterprise system 16 includes one or more servers to provide access to client data 18, e.g., for making decisions related to a particular client or entity (e.g., user of client device 12). Exemplary servers include a mobile application server 132, a web application server 134 and a data server 136. The enterprise system 16 also includes the LLM 10 and the content engine 22 in this example. It can be appreciated that, as discussed above, the LLM 10 may be a third party LLM 10 and that more than one LLM 10 may be utilized by the content engine 22 and/or enterprise system 16.

Although not shown in FIG. 9, as noted above, the enterprise system 16 may also include a cryptographic server for performing cryptographic operations and providing cryptographic services. The cryptographic server can also be configured to communicate and operate with a cryptographic infrastructure. The enterprise system 16 may also include one or more data storage elements for storing and providing data for use in such services, such as data storage for storing client data 18.

Mobile application server 132 supports interactions with a mobile application installed on client device 12. Mobile application server 132 can access other resources of the enterprise system 16 to carry out requests made by, and to provide content and data to, a mobile application on client device. In certain example embodiments, mobile application server 132 supports a mobile banking application to provide payments from one or more accounts of user, among other things.

Web application server 134 supports interactions using a website accessed by a web browser application running on the client device. It can be appreciated that the mobile application server 132 and the web application server 134 can provide different front ends for the same application, that is, the mobile (app) and web (browser) versions of the same application. For example, the enterprise system 16 may provide a banking application that be accessed via a smartphone or tablet app while also being accessible via a browser on any browser-enabled device.

The client data 18 can include, in an example embodiment, financial data that is associated with users of the client devices (e.g., customers of the financial institution). The financial data may include any data related to or derived from financial values or metrics associated with customers of a financial institution system (i.e. the enterprise system 16 in this example), for example, account balances, transaction histories, line of credit available, credit scores, mortgage balances, affordability metrics, investment account balances, investment values and types, among many others. Other metrics can be associated with the financial data, such as financial health data that is indicative of the financial health of the users of the client devices.

In FIG. 10, an example configuration of a client device 12 is shown. In certain embodiments, the client device 12 may include one or more processors 150, a communications module 152, and a data store 162 storing device data 164 and application data 166. Communications module 152 enables the client device 12 to communicate with one or more other components of the computing environment 8, such as the enterprise system 16 and/or LLM 10, via a bus or other communication network, such as the communication network 14. While not delineated in FIG. 10, the client device 12 includes at least one memory or memory device that can include a tangible and non-transitory computer-readable medium having stored therein computer programs, sets of instructions, code, or data to be executed by processor 150. FIG. 10 illustrates examples of modules and applications stored in memory on the client device 12 and executed by the processor 150. It can be appreciated that any of the modules and applications shown in FIG. 10 may also be hosted externally and be available to the client device 12, e.g., via the communications module 152.

In the example embodiment shown in FIG. 10, the client device 12 includes a display module 154 for rendering GUIs and other visual outputs on a display device such as a display screen, and an input module 156 for processing user or other inputs received at the client device 12, e.g., via a touchscreen, input button, transceiver, microphone, keyboard, etc. The client device 12 may also include an LLM module 158, which may take the form of a customized app, plug-in, widget, or software component provided by the LLM 10 for use by the client device 12 to use in communicating with the LLM 10. Similarly, the client device 12 may include the enterprise system client application 24 provided by the enterprise system 16. The client device 12 in this example embodiment also includes a web browser application 160 for accessing Internet-based content, e.g., via a mobile or traditional website. The data store 162 may be used to store device data 164, such as, but not limited to, an IP address or a MAC address that uniquely identifies client device 12 within environment 8. The data store 162 may also be used to store application data 168, such as, but not limited to, login credentials, user preferences, cryptographic data (e.g., cryptographic keys), etc.

It will be appreciated that only certain modules, applications, tools and engines are shown in FIGS. 2-10 for ease of illustration and various other components would be provided and utilized by the LLM 10, client device 12, content engine 22, and enterprise system 16 as is known in the art.

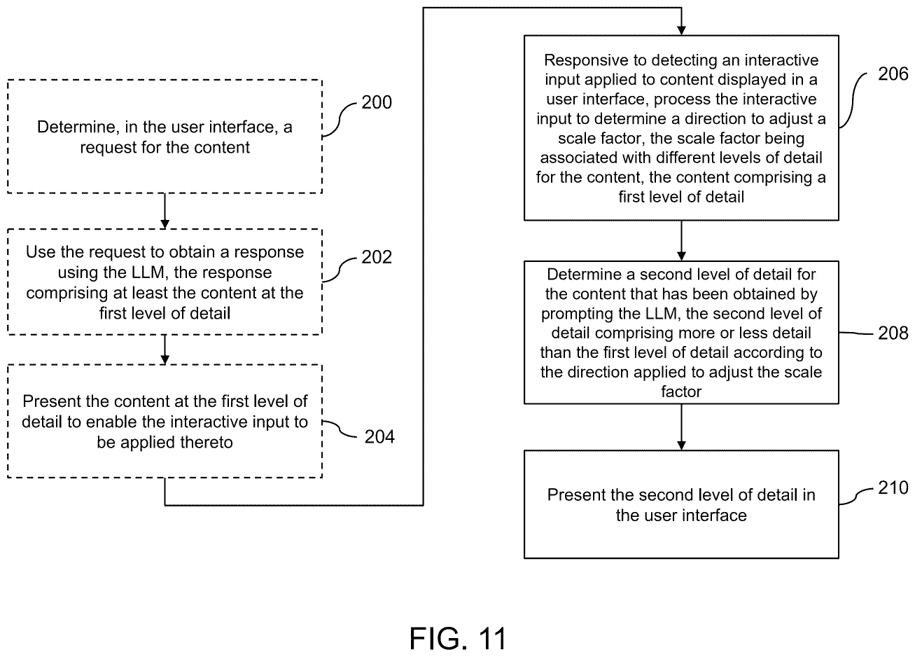

Referring now to FIG. 11, a flow chart illustrates operations that may be performed in adjusting content levels in user interfaces. At block 206, responsive to detecting an interactive input 34 that is applied to content portion 60 displayed in a UI (e.g., as shown in FIGS. 6 and 7), the content engine 22 may process the interactive input 34 (e.g., using the input detector 30 and/or content summarizer 32), to determine a direction to adjust a scale factor. As discussed herein, the scale factor can be associated with different levels 62 of detail for the content portion 60 (e.g., see FIG. 5). The content that is interacted with in block 206 may be considered a first level 62 of detail.

At block 208, the content engine 22 may determine a second level 62 of detail for the content portion 60. This second level 62 of detail may have been obtained by prompting the LLM 10, either as a pre-processing and caching operation, or in real-time or otherwise dynamically at the time of receiving the interactive input 34. The second level 62 of detail may include more or less detail than the first level 62 of detail, according to the direction applied (e.g., up/down, more/less, etc.) to adjust the scale factor. This was illustrated in, for example, FIGS. 6 and 7 herein. At block 210, the content engine 22 may have the UI present the second level 62 of detail in the UI.

As illustrated in FIG. 11, optionally, the interactive input 34 may be associated with a request for the content portion 60. At block 200, the input detector 30 may determine, in the UI, a request for the content portion 60. At block 202, the request may be used to obtain a response, e.g., using the LLM 10. The response may include at least the content at the first level 62 of detail (e.g., as shown in FIG. 6a) or may include multiple levels 62 of detail as discussed above. At block 204, the content portion 60 is presented at the first level 62 of detail to enable the interactive input 34 to be applied thereto, namely at block 206 described earlier.

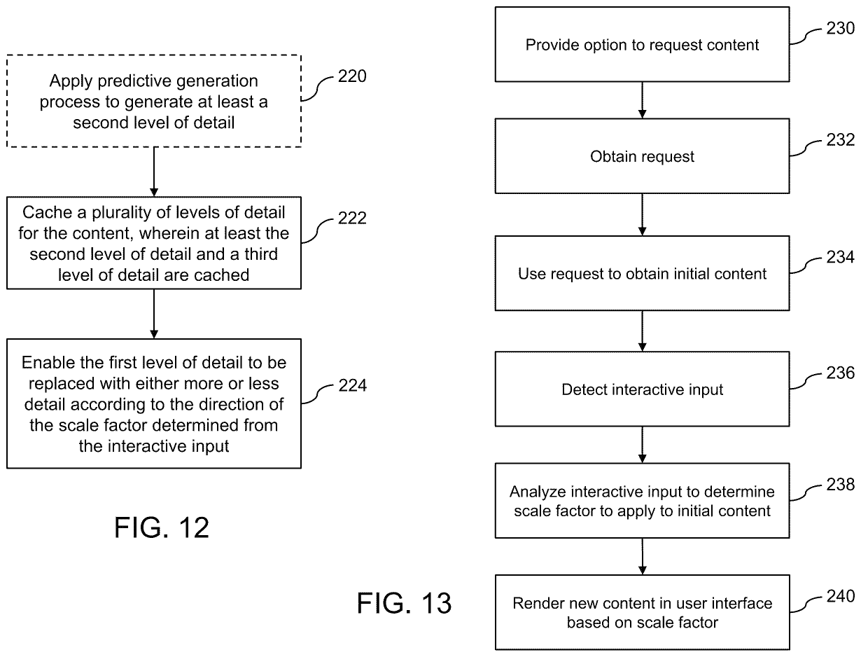

FIG. 12 is a flow chart illustrating example operations that may be performed in generating and/or caching multiple levels 62 of detail associated with content portion 60. At block 222, the content engine 22 may cache multiple levels 62 of detail for the content portion 60, e.g., as shown in FIG. 5. In the examples described herein, based on initial content 70a, second and third levels 62 of detail (e.g., first and second modified content portions 70b, 70c) may be cached. For example, given initial content 70a, the content engine 22 may pre-generate both less and more detailed versions of the initial content 70a. This enables, at block 224, the first level 62 of detail to be replaced with either more or less detail according to the direction of the scale factor determined from the interactive input 34, e.g., as illustrated in FIG. 11. Optionally, at block 220, a predictive generation process may be used and applied to generate at least the second level 62 of detail, e.g., to pre-emptively obtain the different levels 62 of detail of the content portion 60 to reduce latency when reacting to the interactive input 34.

FIG. 13 is a flow chart illustrating example operations that may be performed in generating and dynamically adjusting the level of detail in content based on a request for such content. At block 230, an option may be provided to request content, e.g., entry box 66 shown in FIGS. 6a-6c. At block 232, the UI may obtain a request and use the request at block 234 to obtain the initial content 70a. At block 236, the UI detects an interactive input 34, e.g., using the input detector 30, and, at block 238, analyzes the interactive input 34 to determine the scale factor to apply to the initial content 70a. At block 240, the UI may render new content (e.g., content 70b, 70c) based on the scale factor, which may provide more or less detail or more or less overall content, etc.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of any of the servers or other devices in the computing environment 8, or accessible or connectable thereto. Any application or module herein described may be implemented using computer readable/executable instructions that may be stored or otherwise held by such computer readable media.

It will also be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A computing system for dynamically adjusting content levels in user interfaces, the computing system comprising:
a processor; and
a memory coupled to the processor, the memory storing computer executable instructions that when executed by the processor cause the computing system to:
responsive to detecting an interactive input applied to content displayed in a user interface, process the interactive input to determine a direction to adjust a scale factor, the scale factor being associated with different levels of detail for the content, the content comprising a first level of detail;
determine a second level of detail for the content that has been obtained by prompting a large language model (LLM), the second level of detail comprising more or less detail than the first level of detail according to the direction applied to adjust the scale factor; and
present the second level of detail in the user interface.

2. The computing system of claim 1, wherein the system further comprises instructions to:
determine, in the user interface, a request for the content;
use the request to obtain a response using the LLM, the response comprising at least the content at the first level of detail; and
present the content at the first level of detail to enable the interactive input to be applied thereto.

3. The computing system of claim 2, wherein the request for the content prompts the LLM to obtain a plurality of levels of detail.

4. The computing system of claim 3, wherein the system further comprises instructions to:
cache the plurality of levels of detail for the content, wherein at least the second level of detail and a third level of detail are cached to enable the first level of detail to be replaced with either more or less detail according to the direction of the scale factor determined from the interactive input.

5. The computing system of claim 2, wherein the system further comprises instructions to:
analyze the user interface to determine the request.

6. The computing system of claim 1, wherein the second level of detail is obtained by prompting the LLM responsive to detect the interactive input.

7. The computing system of claim 1, wherein the second level of detail is presented by revising the first level of detail.

8. The computing system of claim 1, wherein the second level of detail is presented by replacing the content having the first level of detail with new content.

9. The computing system of claim 1, wherein the LLM is prompted to provide the different level of detail.

10. The computing system of claim 1, wherein the computing system processes a response from the LLM to generate the second level of detail.

11. The computing system of claim 10, wherein the computing system further comprises instructions to:
apply a predictive generation process to the response from the LLM to generate at least the second level of detail.

12. The computing system of claim 1, wherein the interactive input comprises gesture applied to the user interface.

13. The computing system of claim 12, wherein the gesture comprises a pinch-to-zoom gesture applied to the content to increase or decrease the scale factor.

14. The computing system of claim 1, wherein the interactive input is applied to a first portion of content in the user interface, the user interface presenting a plurality of portions of content to which the interactive input can be applied to adjust the level of detail for that content.

15. A method for dynamically adjusting content levels in user interfaces, the method being implemented by a computing system and comprising:
responsive to detecting an interactive input applied to content displayed in a user interface, processing the interactive input to determine a direction to adjust a scale factor, the scale factor being associated with different levels of detail for the content, the content comprising a first level of detail;
determining a second level of detail for the content that has been obtained by prompting a large language model (LLM), the second level of detail comprising more or less detail than the first level of detail according to the direction applied to adjust the scale factor; and
presenting the second level of detail in the user interface.

16. The method of claim 15, further comprising:
determining, in the user interface, a request for the content;
using the request to obtain a response using the LLM, the response comprising at least the content at the first level of detail; and
presenting the content at the first level of detail to enable the interactive input to be applied thereto.

17. The method of claim 16, wherein the request for the content prompts the LLM to obtain a plurality of levels of detail.

18. The method of claim 17, further comprising:
caching the plurality of levels of detail for the content, wherein at least the second level of detail and a third level of detail are cached to enable the first level of detail to be replaced with either more or less detail according to the direction of the scale factor determined from the interactive input.

19. The method of claim 16, further comprising:
analyzing the user interface to determine the request.

20. A non-transitory computer readable medium storing computer-executable instructions for dynamically adjusting content levels in user interfaces, comprising computer-executable instructions that, when executed by a computing system, cause the computing system to:
responsive to detecting an interactive input applied to content displayed in a user interface, process the interactive input to determine a direction to adjust a scale factor, the scale factor being associated with different levels of detail for the content, the content comprising a first level of detail;
determine a second level of detail for the content that has been obtained by prompting a large language model (LLM), the second level of detail comprising more or less detail than the first level of detail according to the direction applied to adjust the scale factor; and
present the second level of detail in the user interface.
